(19) United States
(12) Patent Application Publication
(10) Pub. No.: US 2011/0064151 A1
(43) Pub. Date: Mar. 17, 2011

(54) Dispersion control in underwater electromagnetic communications systems

(76) Inventors: Mark Rhodes, West Lothian (GB); Brendan Hyland, Edinburgh (GB)

(21) Appl. No.: 12/597,671

(22) PCT Filed: Apr. 29, 2008
(86) PCT No.: PCT/GB08/01500

§ 371 Date: Nov. 30, 2010

(30) Foreign Application Priority Data
May 1, 2007 (GB) 0709128.3

(51) Int. Cl. H04B 13/02; H04L 27/28

(52) U.S. Cl. 375/260; 340/850

(57) ABSTRACT

A data communication system comprising a transmitter for transmitting an electromagnetic and/or magneto-electric signal, a receiver for receiving an electromagnetic and/or magneto-electric signal, and means for compensating for reducing or substantially eliminating signal dispersion, wherein at least one of the transmitter and receiver is underwater.

The present invention relates to a system and method for reducing or removing unwanted electromagnetic and/or magneto-electric signal dispersion in communication systems operating underwater or in other media whose propagation properties are wholly or partly frequency dependent.

### BACKGROUND

Recent increases in underwater operations have brought diverse associated requirements for communication amongst vehicles, machinery, equipment, instrumentation and people, all or some of which may be underwater when communicating. While certain means of underwater communication are well known, the nature of the underwater environment severely limits the performance of communication methods conventionally adopted above ground. Such methods include electromagnetic and/or magneto-inductive communication, which possesses capabilities that lead it to be preferred for certain applications underwater. For example, electromagnetic and/or magneto-inductive communication is immune to turbidity that prevents useful optical communication; and to noise, reflection and refraction effects, which limit acoustic communication. Furthermore, high data rates are possible over short local links, and longer distances are largely unaffected when communication is required across an air-to-water boundary. Many aspects and applications of electromagnetic and/or magneto-inductive communication underwater and in dispersive environments are described in our co-pending patent applications, namely: “Underwater Telecommunications”, PCT/GB2006/002123; “Underground Data Communication System”, GB0613081.9; and “Underwater Electrically Insulated Connection”, PCT/GB2007/000676. The contents of these are hereby incorporated by reference.

While offering advantages, one drawback to be considered in electromagnetic and/or magneto-electric communication is the relatively rapid amplitude attenuation of signal with distance. This results from distributed power dissipation arising due to the partially conductive character of water as a propagation medium. Unlike free-space or air, which have essentially no conductivity, typical fresh water in rivers and lakes has a conductivity of around 0.01 S/m (Siemens/metre) or less, and sea water has much greater conductivity of around 4 S/m, with some dependence on salinity and temperature. Appreciable conductivity in a medium alters electromagnetic behaviour very significantly and means that the usual mathematical equations that describe the behaviour of propagating and inductive fields must be modified accordingly. It may be shown for propagating electromagnetic waves that the attenuation, expressed in decibels (dB), increases in proportion to the square root of frequency. As will be discussed, not only amplitude attenuation is affected.

Examination of the field equations and practical measurements both show that frequency dependent characteristics arise in the behaviour of electrical and magnetic fields due to the partially conductive medium of water, especially sea water whose conductivity is relatively high. These characteristics may be described as a type of frequency dependent dispersion, but of a form that does not in general occur in conventional (e.g. terrestrial radio) communication. In its common application, also used here, ‘dispersion’ means that, between a transmitter and receiver, signals of differing frequency suffer different degrees of attenuation and/or delay. In practice both will be present inherently in the medium of the link itself and are unavoidable.

For a practical data communication signal (e.g. a modulated carrier) with components spread across a significant bandwidth, dispersion results in distortion when a conventional receiver detects the signal. One effect is that each received data symbol is influenced by a residual tail from previous symbols, a phenomenon referred to as intersymbol interference. This can cause difficulties when higher data rates are attempted. Consequently, without remedial action, the maximum rate at which any communication link can operate will be severely restricted if intersymbol interference is sufficient to cause errors in symbol interpretation by a receiver.

For an ideal channel, dispersion across the frequency band of a communication signal should be zero, in which case the channel can be referred to as dispersion free. That is, the amplitude attenuation should be ‘flat’ or constant with respect to frequency, and the delay also should be constant. A constant delay implies a channel phase-shift, which is directly proportional to frequency and, as will be known to those skilled in communications analysis, the channel may be said to demonstrate flat group delay. However, communication channels underwater do not exhibit these ideal characteristics and are far from being dispersion free. Consequently the severe restriction in achievable data-rate has been hitherto a significant disincentive to the adoption of electromagnetic and/or magneto-inductive communication in underwater and other dispersive environments.

### SUMMARY OF THE INVENTION

According to one aspect of the present invention, there is provided a data communication system comprising a transmitter for transmitting data using electromagnetic and/or magneto-electric means, a receiver for receiving data, and means for compensating for the effects of channel dispersion when operating wholly or partly underwater.

The means for compensating markedly increase the rate at which data may be communicated, thereby enhancing the capability of communication links underwater.

The transmitter includes a transmit antenna. The receiver includes a receive antenna. One or both of the transmit and receive antennas may be underwater and, for the purpose of description. The antennas may be constructed as magnetically coupled conduction loops, but other types are not excluded.

The degree of dispersion compensation required in a data communication system underwater such as the above may be reduced or is eliminated for practical purposes. To realise this, according to another aspect of the invention, there is provided an underwater communication system comprising a transmitter having means for dividing the data to be transmitted into a number of separate parallel streams, each of which is of a lower data-rate, and means for transmitting each stream by modulation of a separate carrier. The system also includes a receiver that has means for demodulating the carriers to recreate the original data by aggregating the separate streams.

Because the bandwidth of each modulated signal may be much less than that required by a signal carrying the aggregate stream, each encounters commensurately reduced dispersion and therefore much less intersymbol interference. The compensation required for dispersion affecting each signal is thereby considerably reduced or, if sufficient carriers are adopted, the dispersion affecting each may be sufficiently low to avoid the need for any compensation. Consequently, a higher aggregate data rate may be achieved by this method than is possible with a single carrier without dispersion compensation.

### BRIEF DESCRIPTION OF THE DRAWINGS

Various aspects of the invention will now be described by way of example only and with reference to the accompanying drawings, of which:

FIG. 1 is a typical dispersion characteristic of amplitude attenuation with respect to frequency for an electromagnetic signal propagating through sea water;

FIG. 2 is a typical dispersion characteristic of group delay with respect to frequency for an electromagnetic signal propagating through sea water;

FIG. 3 is an outline implementation of a transmit-receive communication link with a compensation process introduced substantially to equalise or eliminate the effects of dispersion in the channel.

FIG. 4 is one possible compensation method and, in this example, is adaptive to changing channel conditions.

### DETAILED DESCRIPTION OF THE INVENTION

The present invention relates to a communication data link that is wholly or partially underwater and provided by electromagnetic and/or magneto-inductive means. Because the underwater medium is significantly different from free space or air, resultant dispersion is largely or partially overcome in one aspect of this invention by equalisation or compensation for its effects. By including such compensation for the adverse dispersive characteristics of the channel, the data rate possible over an underwater communication link can be increased.

Electromagnetic and/or magneto-inductive communication may be adopted underwater at very high data rates over short distances (in the order of 0 to 2 metres), and at lower data rates over longer distances (in the order of up to several hundred metres or more). The achievable distance is dependent on many factors including transmit power, type and sizes of transmit and receive antennas, conductivity of the water, and the extent to which any part of the transmission path may be out of water. However, the introduction of a dispersion compensation process is applicable and beneficial to all data rates and distances.

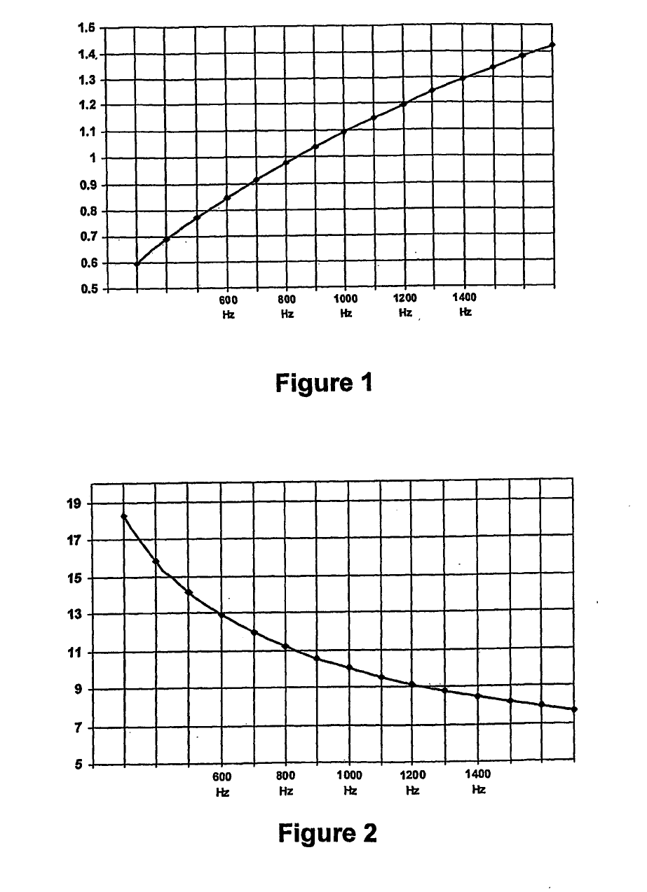

FIG. 1 depicts the attenuation of a typical propagation channel for a signal in seawater (of typical conductivity 4 S/m) as a function of frequency, and is expressed in dB per metre of distance. The near-field magneto-inductive attenuation characteristic is generally similar, though not identical, and the field of a transmitted signal will comprise components of both near-field and propagating field (far-field) in varying proportions dependent on distance from the transmit antenna. This example attenuation graph is centred on 1 kHz, but a similar shape is found proportionately at other centre frequencies including much higher frequencies. A typical communication signal could occupy all or a portion of this bandwidth but, as can be seen, the slope of the characteristic is such that there will be significant differences in attenuation across the wide bandwidth of a real communication signal, and this disparity will increase approximately in proportion to distance. FIG. 2 depicts the associated group delay of the propagation channel in seawater (typical conductivity 4 S/m) as a function of frequency, and is expressed in microseconds per metre of distance. In similar manner to attenuation, it can be seen that the group delay varies significantly across a typical communication signal bandwidth, and this also will increase approximately in proportion to distance.

A key aspect of this invention is elimination as far as possible of the non-flat attenuation and delay characteristic encountered in underwater communication. If this unwanted characteristic is considered as similar to a network transfer function, it is possible to introduce in tandem with the signal path a compensating network, operative within the necessary signal bandwidth, which, when added to the unwanted characteristic, results in a desired flat (or nearly flat) overall transfer function. Thus, compensation is provided which effectively cancels the dispersion of the channel, which may then be described as ‘equalised’. It is usually most practical and convenient to place the compensating network in the receiver, before its data symbol detection process. However, sometimes it may be possible to incorporate the compensation in the transmitter before the signal is transmitted.

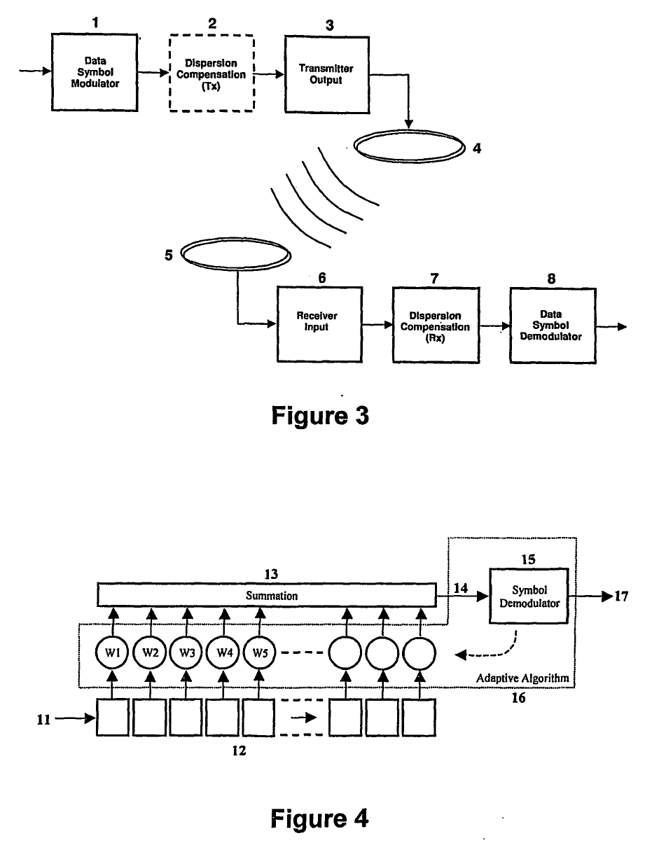

FIG. 3 shows an underwater communications system. This has a transmitter and a receiver. The transmitter includes a data symbol modulator 1 that is fed to a transmitter output 3, which drives an antenna 4. Optionally, dispersion compensation 2 may be applied after the data symbol modulator 1. The receiver includes an antenna 5, a receiver input 6 and a data symbol demodulator 8. Optionally, dispersion compensation 7 may be applied before the data symbol demodulator 8.

Both the transmitter and receiver respectively have a waterproof, electrically insulated magnetic coupled antenna. A magnetic coupled antenna is used because water is an electrically conducting medium, and so has a significant impact on the propagation of electromagnetic signals. Ideally, each insulated antenna assembly is surrounded by a low conductivity medium that is impedance matched to the propagation medium, for example distilled water. In applications where long distance transmission is required, the magnetic antenna should preferably be used at lowest achievable signal frequency. This is because signal attenuation in water increases as a function of increasing frequency. Hence, minimising the carrier frequency where possible allows the transmission distance to be maximised. In practice, the lowest achievable signal frequency will be a function of the desired bit rate and the required distance of transmission.

In accordance with the invention, dispersion compensation is included at one or both of the transmitter and receiver. If the magnitude and form of the dispersion are known or may be estimated, and relatively stable in magnitude, then the signal may be ‘pre-compensated’ in the transmitter, or ‘post-compensated’ in the receiver, or a combination of both. Even where the dispersion is not accurately known, it may be possible to provide partial compensation of a compromise nature. For example, a compensation network could be arranged to compensate about half of the dispersion variation expected to be encountered, thereby over-compensating some channel situations and under-compensating others. While this cannot provide all the precise compensation values required in the range of dispersion encountered, it will nevertheless provide some improvement and be better than no compensation.

In most applications, however, the compensation required is very variable and somewhat unpredictable, particularly because the unknown and changeable distance of the communications link will have a large effect on the dispersion that has to be equalised. Moreover, at its maximum value the required compensation may be large and require to be reasonably accurately provided, so that fast data communication is not prevented or impaired. In order to cope with such unknown and variable degrees of dispersion, variable compensation is usually preferable. Moreover, the overall system will have much greater practical utility if the degree of compensation can adapt automatically to equalise whatever dispersion is encountered. Known methods exist for automatic equalisation of terrestrial communication channels, and some of these may be applied in this invention to the new form of dispersion found in electromagnetic and/or magneto-electric communication underwater.

Automatic compensation is applied typically in the receiver as previously discussed, but features the added capability that adjustment is performed autonomously based on information derived from the incoming ‘constellation’ of modulation symbols. Those skilled in data communication techniques will be aware of the concept whereby a set of possible modulation phase and/or amplitude positions represent data symbols in typical well known transmission systems, which collective set is commonly referred to as a constellation. Examination by a receiver of the displacements of constellation points from their ideal positions allows automatic adjustment of a compensation network such as to minimise these displacements. An automatically operative algorithm converges on a stable adjustment of the compensation network parameters such that symbol displacements (and hence intersymbol interference) are minimised at the point of demodulation, thereby maximising the likelihood of correct detection of the transmitted symbols.

In FIG. 4, those skilled in data communication will recognise the outline arrangement of a receiver's transversal equaliser network used typically to compensate for dispersion in telephony modem applications and elsewhere. Successive samples (usually represented in digital form) of the received signal 11 are transported along a chain of delayed positions 12 under the direction of a clock (not shown). The output 14 of the transversal equaliser is formed from a weighted summation 13 of the outputs of the successive delayed positions. Before summation, the outputs of the delayed positions are each multiplied respectively by a parameter (W1, W2, W3, etc.)

The characteristic transfer function of the transversal network is determined by the set of individual weightings (W1, W2, W3, etc.) applied to the outputs before summation. Appropriate variation of this set of weightings changes the transfer function of the transversal network and, under the direction of an adaptive control algorithm 16 which assesses and acts upon information about data symbol deviations measured by the demodulator 15, the network can be arranged to minimise the deviations. This ensures that the signal output 17 of the symbol demodulator 15 has its likelihood of correct symbol detection maximised. Moreover, the algorithm can track (continually adjust to accommodate) any ongoing dispersive variations, which may arise in the channel, perhaps due to relative changes in distance between transmitter and receiver.

Under severe channel dispersion it sometimes can be impossible for the control algorithm to converge on the correct or any reasonable compensation using the unknown and somewhat random data transmitted as normal traffic. For this reason, at commencement of link operation it may be necessary to send a short period of a known ‘training sequence’ of symbols upon which the algorithm can obtain initial convergence more readily. After this training period the algorithm can track any changes to the channel. In practice, an equaliser will have many more delay positions than represented in FIG. 4.

A typical equalisation process also can provide compensation for other sources of dispersion, such as arising from the effects of inductive reactance in antennas, filtering deficiencies, and from multipath reflections, which may cause a received signal to be an aggregation of signals received by more than one path with differing delays. If present, these dispersive effects will add to those due to underwater propagation and will usually be accommodated by the same equalisation process. It will be recognised that other forms of fixed, manually variable, and automatically variable equaliser networks may be adopted instead. Moreover, it will be understood that, within the scope of the concepts of this invention, the implementations outlined here are examples only and not exclusive possibilities.

In another aspect of this invention the requirement for equalisation may be reduced considerably, or decreased to such a negligible level that equalisation may be omitted altogether in practical applications. As will be familiar to those skilled in communications, frequency division multiplexing systems allow a number of data streams to be sent in parallel over a common channel of sufficient bandwidth. According to an aspect of this invention, a channel based on electromagnetic or magneto-inductive means, partly or wholly underwater, is divided into many sub-channels each of which is formed typically of a carrier modulated at a low data-rate, which low rate thereby allows each sub-channel signal to be designed with a low bandwidth. Because each modulated carrier signal has a low bandwidth the dispersion it encounters is much less than that which would be encountered by a single signal occupying the larger underwater channel bandwidth required by the aggregate data rate. By sufficiently reducing the data-rate of each sub-channel (by choosing an adequately large number of sub-channels), each signal can be restricted to an arbitrarily low bandwidth, and hence dispersion to a negligibly low level.

The original data stream to be transmitted underwater is divided into a number of data streams so that each may be transmitted over a sub-channel and, at the receiver the individual data streams are reassembled into the original data stream. By arranging for a sufficiently large number of sub-channels, typically in the range of 10 to 1000, the dispersion encountered by each is reduced by a factor approximately proportional to the number of sub-channels. If a sufficient number of sub-channels are arranged the dispersion can be considered negligibly small, thereby avoiding any need for dispersion compensation.

Any form of frequency division multiplexing may be adopted, but particularly beneficial is the technique well known in communications as orthogonal frequency division multiplexing. In this type of system, the multiplexed signals transmitted are arranged to be mutually orthogonal so they may be closely packed together in the frequency band and yet avoid mutual interference to a high degree. Thus, the bandwidth required for underwater transmission by the orthogonal frequency division multiplexing system is almost the same as required by a single carrier modulated at the much higher aggregate rate, but the effects of dispersion are reduced or are small enough to be neglected in practice.

Those skilled in communication will be familiar with methods by which a frequency division multiplexing system may be created. When incorporated with the underwater communication techniques referred to, the need for dispersion compensation and associated adaptation are reduced or avoided. As will be understood, other frequency division multiplexing methods and details of implementation may be adopted within the scope of this invention. Although typically applied to a communication channel in a medium wholly or partly water, this invention also applies advantageously to any other medium with a dispersive characteristic.

1. A data communication system comprising a transmitter for transmitting an electromagnetic and/or magneto-electric signal, a receiver for receiving an electromagnetic and/or magneto-electric signal, and means for compensating for reducing or substantially eliminating signal dispersion, wherein at least one of the transmitter and receiver is underwater.

2. A data communication system according to claim 1, wherein the dispersion compensation means are incorporated as part of, or in close association with, the receiver.

3. A data communication system according to claim 1, wherein the dispersion compensation means are incorporated as part of, or in close association with, the transmitter.

4. A data communication system according to claim 1, wherein the dispersion compensation means are incorporated partly in the transmitter and partly in the receiver, or in close associations with the transmitter and the receiver.

5. A data communication system according to claim 1, wherein the dispersion compensation means are operative to adapt automatically to dispersion encountered in a transmission channel whose dispersive characteristic is previously unknown.

6. A data communication system according to claim 5, wherein the dispersion compensation means are operative to adapt automatically to dispersion encountered and to dispersion changes over time in a transmission channel.

7. A data communication system according to claim 1, wherein the dispersion compensation means provide a compensation characteristic which can be fixed and predetermined or can be changed by manual intervention.

8. A data communication system according to claim 1, wherein the dispersion compensation means include a transversal filter network.

9. A data communication system comprising a transmitter for transmitting an electromagnetic and/or magneto-electric signal, a receiver for receiving an electromagnetic and/or magneto-electric signal, which signal comprises a plurality of frequency channels each of which carries part of the data and occupies a portion of the overall signal bandwidth, wherein at least one of the transmitter and receiver is underwater.

10. A data communication system according to claim 9, wherein the frequency channels are constructed and arranged according to a method of orthogonal frequency division multiplexing.

11. (canceled)

12. A data communication system according to claim 9, in which the communication medium is a dispersive medium other than water.
